(19) United States
(12) Patent Application Publication
(10) Pub. No.: US 2003/0020392 A1
(43) Pub. Date: Jan. 30, 2003

(54) Optimal inner shield assembly for shielding an external magnetism in a color cathode ray tube

(76) Inventor: Jae Yeul Kim, Daegu-si (KR)

Correspondence Address: BIRCH STEWART KOLASCH & BIRCH, PO BOX 747, FALLS CHURCH, VA, 22040-0747, US

(21) Appl. No.: 10/157,813

(22) Filed: May 31, 2002

(30) Foreign Application Priority Data
Jul. 25, 2001 (KR) 44872/2001

(51) Int. Cl. H01J 31/00

(52) U.S. Cl. 313/479

(57) ABSTRACT

The present invention discloses an inner shield assembly which is capable of maximizing an external magnetism shield effect by improving a structure of the inner shield assembly and by optimizing the magnetic characteristic of component material of the improved inner shield assembly.

According to the present invention, an inner shield assembly provided at the rear side of a frame assembly having a main frame and a sub-frame for shielding external magnetism including a main body for shielding the inside of a funnel, a rectangular beam shield combined to the front of the main body, and a front portion 73 formed extending from the edge to the front of the beam shield to surround the shadow mask and the frame assembly, wherein material of the front portion has maximum permeability of at least 3000 and coercivity of at most 1.25 Oe.

In addition, the magnetic characteristic of each of material is adjusted to have an interrelation of 0.5≦μ 2/μ 1≦1.5, where, maximum permeability of material of the main body 71 is μ 1 and maximum permeability of material of the front portion 73 is μ 2. In addition, the magnetic characteristic of each of material is adjusted to have an interrelation of 0.5≦H1/H2≦3.0, where, coercivity of material of the main body 71 is H1 and coercivity of material of the front portion 73 is H2.

### BACKGROUND OF THE INVENTION

1. Field of the Invention

The present invention relates to an inner shield assembly in a color cathode ray tube, more particularly to an inner shield assembly which is capable of minimizing an external magnetism and a variation of magnetism at the time of rotation of direction of the color cathode ray tube so that degradation of color purity of a screen can be prevented by improving a structure of the inner shield assembly and by optimizing magnetic characteristic of a component material of the improved inner shield assembly.

2. Description of the Related Art

FIG. 1 shows a partial sectional view for illustrating a structure of a general color cathode ray tube.

Referring to FIG. 1, the color cathode ray tube, which is primary element for displaying pictures in picture display devices such as television receivers and computer monitors, is generally comprised of a panel 1 provided at the front and a funnel 2 provided at the rear.

In addition, the inside of the flat cathode ray tube, which is divided by the panel 1 and the funnel 2, includes a fluorescent screen 3 that served as a light emission, an electron gun 8 provided in the inside a neck of the funnel 2 for projecting electron beams 11 for light-emitting the fluorescent screen 3, a shadow mask 4 for selecting color of electron beams 11 from the electron gun 8, a frame assembly 5 including a main frame 5a for applying tension to the shadow mask 4 and a sub-frame 5b for supporting the main frame 5a, a spring 6 provided at a side of the main frame 5a for combining the frame assembly 5 and the panel 1, an inner shield 7 welded and fixed to the sub-frame 5b for shielding an external earth magnetism, and a reinforcement band 10 provided at the side of the panel 1 for preventing an external impact.

Further, the outside of the neck of the funnel 2 has a deflection yoke 8 for deflecting up-and-down and left-and-right the electron beams 11 projected from the electron gun (not shown) and two, four and six pole magnets 9 for correcting traveling tracks of the electron so that the projected electron beams 11 hit accurately on a fluorescent substance, thereby degradation of color purity is prevented.

On the other hand, as shown in FIGS. 2 and 3, when electron beams projected from the electron gun (not shown) in the cathode ray tube are affected by an external magnetism, traveling direction of electron beams is changed and the electron beams do not correctly hit on desired fluorescent substance 3a of the fluorescent screen 3 but hit on a black matrix 3b or other fluorescent substance. This event is referred to as “mislanding”. Accordingly, the inner shield 7 is used to shield affection by the external magnetism.

FIGS. 4a and 4b are a deployed view and an assembled view, respectively, for illustrating an example of an inner shield assembly structure of a conventional color cathode ray tube.

As shown in FIGS. 4a and 4b, the inner shield 7 comprises a pyramid-shaped main body 7a and a beam shield 7b combined to a forward end portion of the main body 7a. Also, the inner shield 7 is manufactured using material having a high permeability in order to minimize affection by an external magnetism.

FIGS. 5a and 5b are a deployed view and an assembled view, respectively, for illustrating another example of an inner shield assembly structure of a conventional color cathode ray tube.

As shown in FIGS. 5a and 5b, the inner shield 17 can be formed with an integration of a main body 17a with a beam shield 17b.

However, in a magnetism shield structure such as the conventional inner shields 7 and 17, it is not bonded to the sub-frame 5b, although the shadow mask 4 is bonded up-and-down to the main frame 5a of the frame assembly 5 such that the shadow mask has a portion of the magnetism shield function. Accordingly, since a large space is presented between the shadow mask 4 and the sub-frame 5b, there is a problem that the magnetism shield function cannot be performed in this space.

In addition, since an external magnetism shield effect is affected by the magnetic characteristic of material as well as the inner shield assembly structure, there is a need to adjust the magnetic characteristic of component material of the inner shield assembly in order to maximize the magnetism shield function.

### SUMMARY OF THE INVENTION

Accordingly, the present invention has been made the aforementioned problems of the prior art in mind, and an object of the present invention is to provide an inner shield assembly which is capable of maximizing an external magnetism shield effect by improving a structure of the inner shield assembly and optimizing magnetic characteristic of component material of the improved inner shield assembly.

In order to accomplish the above object, according to the present invention, an inner shield assembly provided at the rear side of a frame assembly having a main frame and a sub-frame for shielding external magnetism including a main body for shielding the inside of a funnel, a rectangular beam shield combined to the front of the main body, and a front portion formed extending from the edge to the front of the beam shield to surround the shadow mask and the frame assembly, wherein material of the front portion has maximum permeability of at least 3000 and coercivity of at most 1.25 Oe.

Preferably, the magnetic characteristic of each of material is adjusted to have an interrelation of 0.5≦μ 2/μ 1≦1.5, where, maximum permeability of material of the main body is μ 1 and maximum permeability of material of the front portion is μ 2. In addition, the magnetic characteristic of each of material is adjusted to have an interrelation of 0.5≦H1/H2≦3.0, where, coercivity of material of the main body is H1 and coercivity of material of the front portion is H2. As a result, an optimal magnetism shield effect can be obtained.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partial sectional view for illustrating a structure of a conventional color cathode ray tube;

FIG. 2 is a state diagram showing movement of electron beams by an effect of earth magnetism in a conventional color cathode ray tube;

FIG. 3 is a view showing a variation of electron beam landing position of A portion of FIG. 2;

FIGS. 4a and 4b are a deployed view and an assembled view, respectively, for illustrating an example of an inner shield assembly structure of a conventional color cathode ray tube;

FIGS. 5a and 5b are a deployed view and an assembled view, respectively, for illustrating another example of an inner shield assembly structure of a conventional color cathode ray tube;

FIGS. 6a and 6b are a deployed view and an assembled view, respectively, for illustrating an inner shield assembly structure of a color cathode ray tube according to the present invention;

FIG. 7 is a graph showing a magnetic hysteresis loop for explaining permeability and coercivity of material employed in the present invention;

FIG. 8 is a graph showing a relation between beam movement and permeability of the front portion material of the inner shield assembly according to the present invention;

FIG. 9 is a graph showing a relation between beam movement and coercivity of the front portion material of the inner shield assembly according to the present invention;

FIG. 10 is a graph showing a relation between beam movement and a ratio of permeability of the front portion to that of main body material of the inner shield assembly according to the present invention;

FIG. 11 is a graph showing a relation between the beam movement and a ratio of coercivity of the main body to that of front portion material of the inner shield assembly according to the present invention.

### DETAILED DESCRIPTION OF THE INVENTION

Hereinafter, preferred embodiments of an inner shield assembly according to the present invention will be described in detail with respect to the accompanied drawings in which the same reference numerals are used throughout the different drawings to designate the same or similar components.

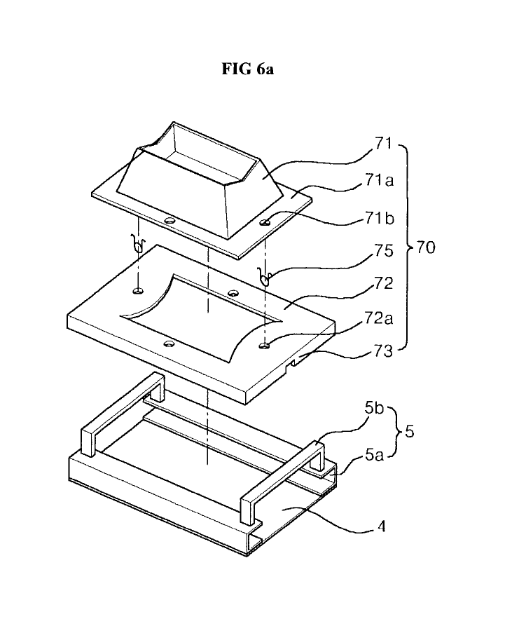

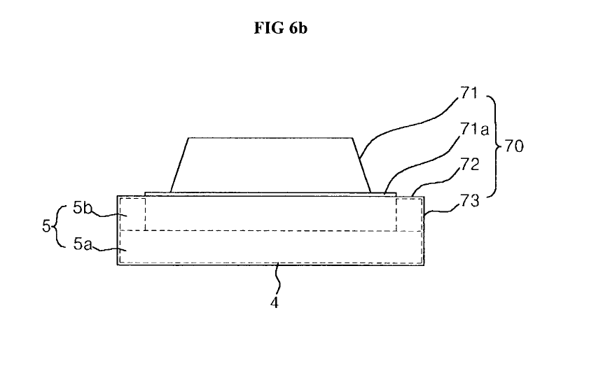

FIGS. 6a and 6b are a deployed view and an assembled view, respectively, for illustrating an inner shield assembly which is an external magnetism shield structure of a color cathode ray tube according to the present invention.

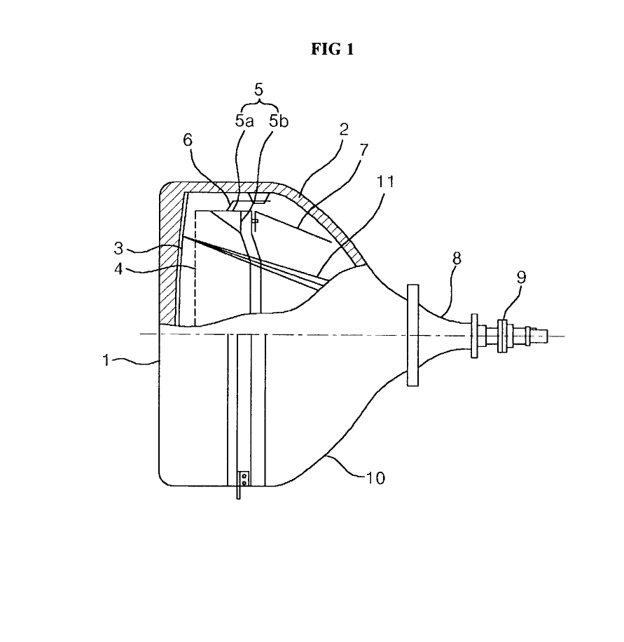

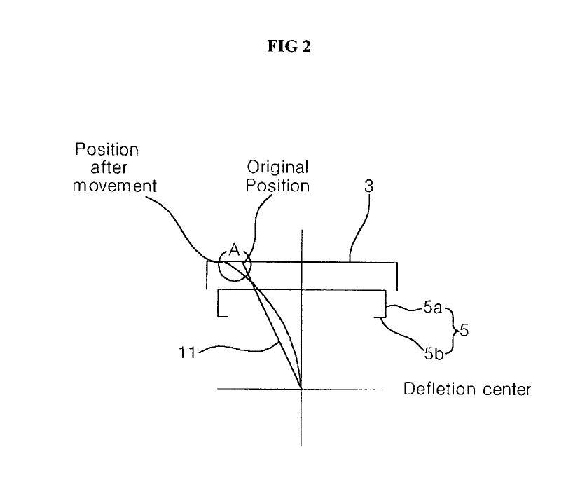

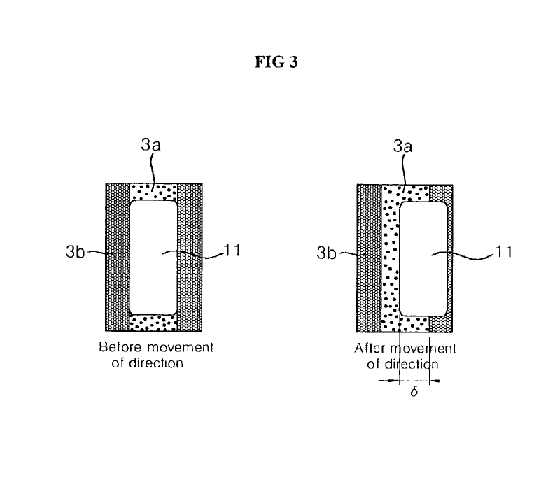

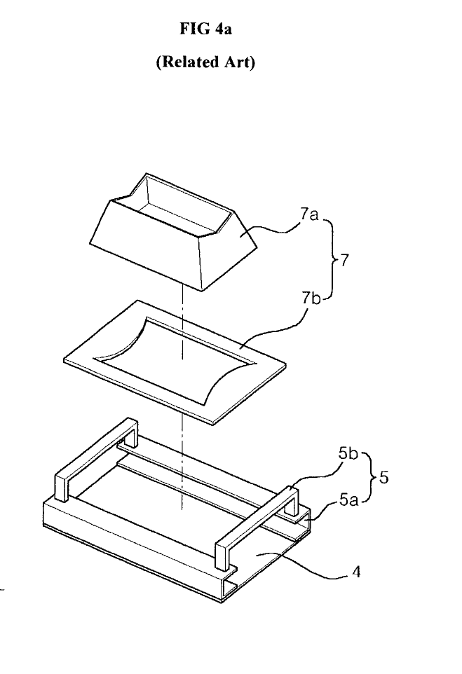

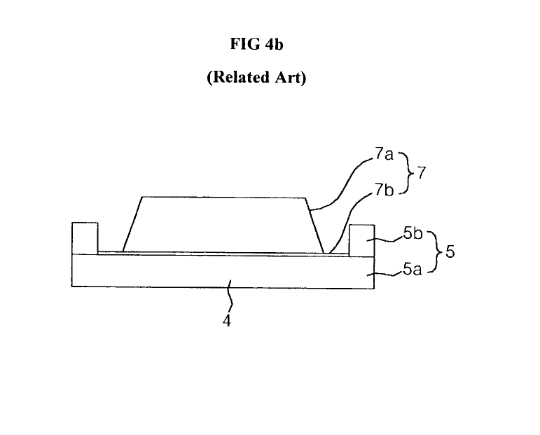

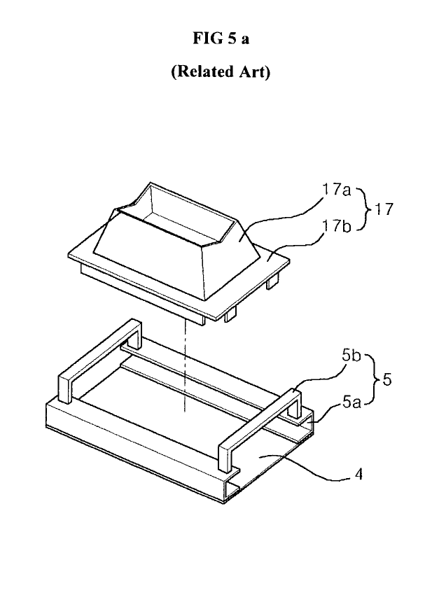

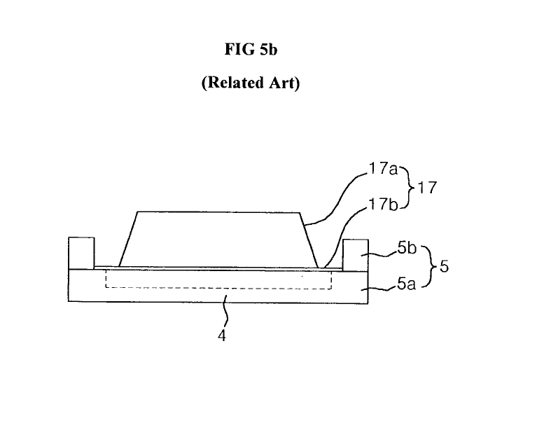

As shown in FIGS. 6a and 6b, an inner shield assembly 70 covers the inside of the funnel (2 in FIG. 1), the frame assembly 5 and the shadow mask 4 in the rear of the frame assembly 5 comprising the main frame 5a and the sub-frame 5b.

In addition, the inner shield assembly 70 generally comprises a rough pyramid-shaped main body 71 for shielding the inside of the funnel, a rectangular beam shield 72 combined to the front of the main body 71, and a front portion 73 formed extending from the edge to the front of the beam shield 72 to surround the shadow mask 4 and the frame assembly 5.

In addition, the beam shield 72 and front portion 73 of the inner shield assembly 70 are integrally formed and the main body 71 is attached to the beam shield 72 by means of a fixture pin 75 in a state that a combining hole 71b formed on a flange 71a of the main body 71 and a combining hole 72a of the beam shield 72a are aligned with registration.

On the other hand, an external magnetism shield effect is affected by thickness and magnetic characteristic of material, as well as the structure of the inner shield assembly 70. The present invention optimizes the magnetic characteristic of component material of the inner shield assembly in order to improve the magnetism shield function.

Accordingly, particularly, there is a need to limit permeability and coercivity of material of the front portion 73 and main body 71 of the inner shield assembly according to the present invention within a predetermined range.

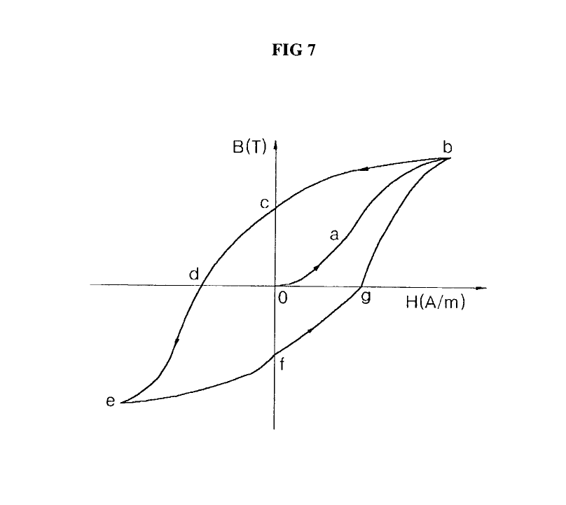

FIG. 7 is a graph showing a magnetic hysteresis loop for explaining permeability and coercivity of material employed in the present invention.

For the purpose of easy understanding, permeability and coercivity of the inner shield assembly of the cathode ray tube are briefly described with reference to FIG. 7 below.

When a magnetizing force H of ferromagnetic substance is increased to some degree, and after that, is decreased, a path that magnetic flux density B is increased when the magnetizing force is increased is not equal to a path that the magnetic flux density is decreased when the magnetizing force is decreased. And, when coercivity is decreased, the magnetic flux density is delayed. This phenomenon is referred to as “magnetic hysteresis” and a curve formed by the paths is referred to as “magnetic hysteresis loop”.

In addition, in the magnetic hysteresis loop in FIG. 7, a curve (oab) is referred to as “normal induction curve”, a magnetic flux density when H=0 is referred to as “residual magnetic flux density (Br)”, and an absolute value of negative magnetizing force when B=0 is referred to as “coercivity(Hc)”.

In addition, point (b) is referred to as “maximum magnetic flux density (Bm)”, a magnetizing force corresponding to the point (b) is referred to as “maximum magnetizing force (Hm)”, a curve (cd) is referred to as “demagnetizing curve”, and product of a magnetic flux density by a magnetizing force at any point on the curve (cd) is referred to as “energy product”.

In addition, a ratio of a magnetic flux density to a magnetizing force at any point on the normal induction curve is referred to as “normal permeability” and a maximum value of the normal permeability is referred to as “maximum permeability”.

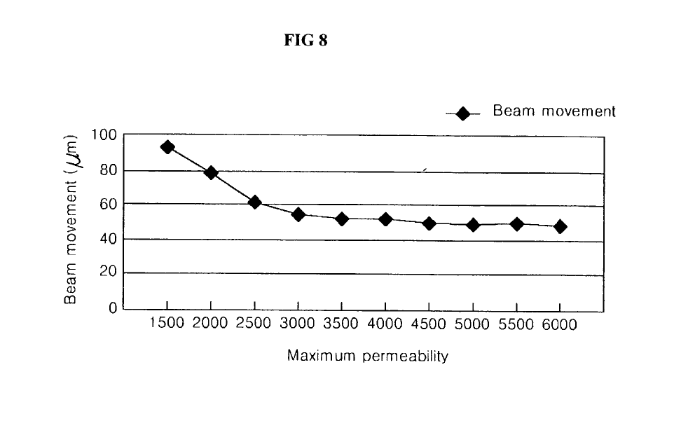

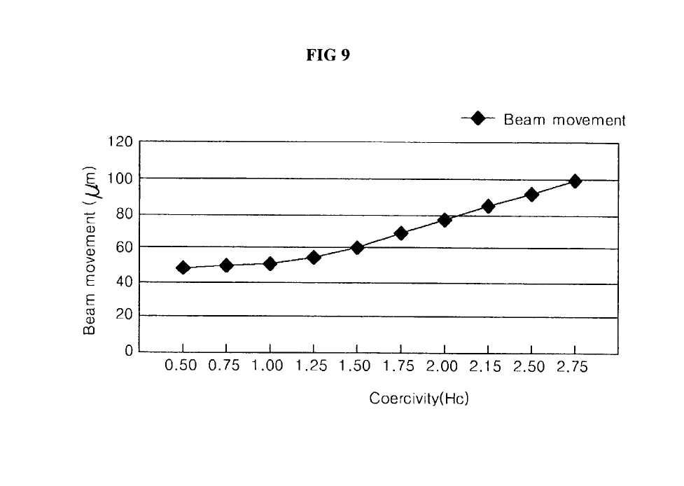

FIG. 8 is a graph showing the relationship between the beam movement and permeability of the front portion material of the inner shield assembly according to the present invention, and FIG. 9 is a graph showing the relationship between the beam movement and coercivity of the front portion material of the inner shield assembly according to the present invention.

The meaning of the magnetism shield is not that magnetism is interrupted, but that an incoming magnetic field is decreased by concentrating magnetism on a material having a good magnetization. Particularly, the material having a good magnetization has a high permeability and a weak coercivity.

In order to prevent the electron beams from hitting on other colors at the time of rotation of direction of the color cathode ray tube so that color purity of a screen is maintained, an amount of movement of beams at the time of such a rotation due to an external magnetism, particularly, an earth magnetism, should be at most 60 μm.

Accordingly, as shown in the graphs of FIGS. 8 and 9, it is preferable that material of the front portion 73 has the maximum permeability of at least 3000 and coercivity of at most 1.25 Oe so that the front portion 73 shields the earth magnetism effectively.

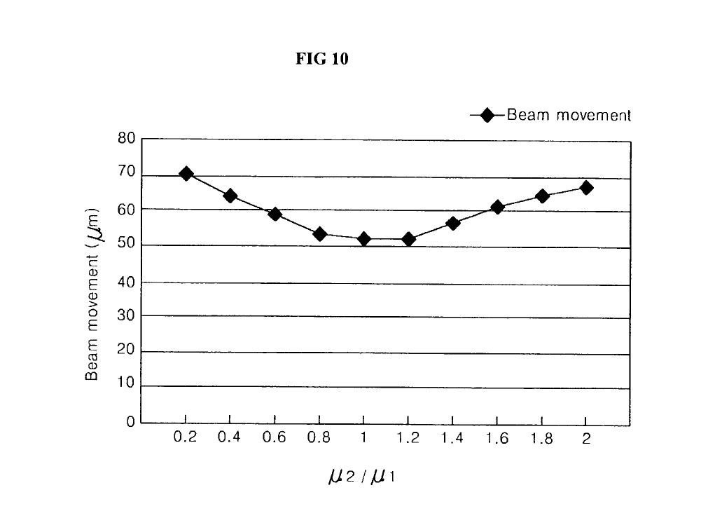

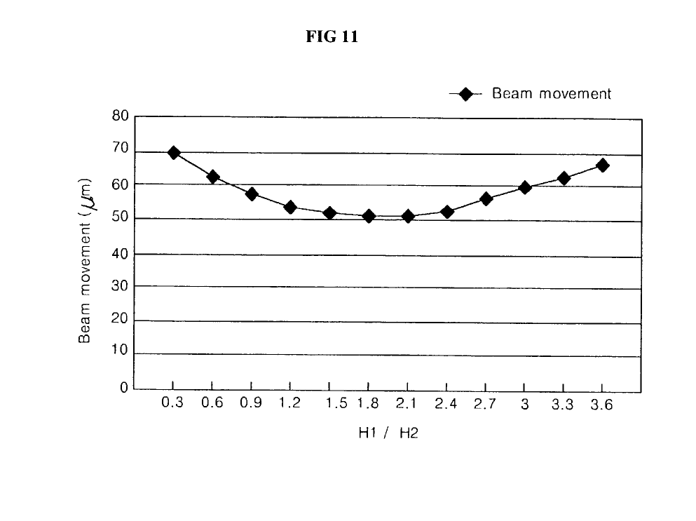

FIG. 10 is a graph showing a relationship between the beam movement and a ratio of permeability of the front portion to that of main body material of the inner shield assembly according to the present invention, and FIG. 11 is a graph showing a relationship between the beam movement and a ratio of coercivity of the main body to that of front portion material of the inner shield assembly according to the present invention.

Similar to the front portion 73, when material having a high maximum permeability and a low coercivity is used as the material of the main body 71, excellent shield effect can be obtained. However, since magnetism is concentrated on the shield material having a high permeability, it is not preferable that magnetic characteristic of material of the front portion 73 is greatly different from that of the main body 71.

Accordingly, as shown in FIGS. 10 and 11, it is required to limit the magnetic characteristic between the front portion 73 and the main body 71 within a predetermined range.

In other words, the magnetic characteristic of each of material is adjusted to have an interrelation of 0.5≦μ 2/μ 1≦1.5, where, maximum permeability of material of the main body 71 is μ 1 and maximum permeability of material of the front portion 73 is μ 2. In addition, the magnetic characteristic of each of material is adjusted to have an interrelation of 0.5≦H1/H2≦3.0, where, coercivity of material of the main body 71 is H1 and coercivity of material of the front portion 73 is H2. As a result, an optimal magnetism shield effect can be obtained.

As described above, according to the present invention, since the inner shield assembly surrounds the whole portion of the shadow mask and the frame assembly, the magnetism shield function can be improved. In addition, since magnetic characteristic of material of each portion of the inner shield assembly is optimized, the magnetism shield effect may be enhanced.

Accordingly, a margin of directional rotation of the cathode ray tube can be increased and the color purity also can be maintained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An inner shield assembly provided at the rear side of a frame assembly having a main frame and a sub-frame for shielding an external magnetism comprising:
a main body for shielding the inside of a funnel;
a rectangular beam shield attached to the front of the main body; and
a front portion formed extending from the edge to the front of the beam shield to surround the shadow mask and the frame assembly, wherein material of the front portion has a maximum permeability of at least 3000.

2. The inner shield assembly according to claim 1, wherein material of the front portion has coercivity of at most 1.25 Oe.

3. The inner shield assembly according to claim 2, wherein a magnetic characteristic of each of material has an interrelation of 0.5≦μ 2/μ 1≦1.5, where, the maximum permeability of material of the main body is μ 1 and the maximum permeability of material of the front portion is μ 2.

4. The inner shield assembly according to claim 2, wherein the magnetic characteristic of each of material has an interrelation of 0.5≦H1/H2≦3.0, where, coercivity of material of the main body is H1 and coercivity of the material of the front portion is H2.

5. The inner shield assembly according to claim 1, wherein the magnetic characteristic of each of material has an interrelation of 0.5≦μ 2/μ 1≦1.5, where, maximum permeability of material of the main body is μ 1 and maximum permeability of material of the front portion is μ 2.

6. The inner shield assembly according to claim 1, wherein the magnetic characteristic of each of a material has an interrelation of 0.5≦H1/H2≦3.0, where, coercivity of material of the main body is H1 and coercivity of material of the front portion is H2.
